(19) United States
(12) Patent Application Publication
(10) Pub. No.: US 2002/0107747 A1
(43) Pub. Date: Aug. 8, 2002

(54) System and method for brokering food order transactions among a plurality of unaffiliated sellers

(75) Inventor: Dimitra G. Gerogianni, Arlington, MA (US)

Correspondence Address: Baker Botts L.L.P., Suite 600, 2001 Ross Avenue, Dallas, TX, 75201-2980, US

(73) Assignee: i2 Technologies, Inc.

(21) Appl. No.: 09/776,130

(22) Filed: Feb. 2, 2001

(51) Int. Cl. G06F 17/60

(52) U.S. Cl. 705/26

(57) ABSTRACT

A system (10) for brokering food order transactions among multiple unaffiliated sellers (14) includes one or more databases containing delivery information associated with each of possibly multiple of buyers (12), availability information identifying food items available from each of multiple unaffiliated sellers (14), pricing information for the food items available from each seller (14), and delivery information for each seller (14) that includes a delivery area for the seller (14) and substantially real-time delivery time information for the seller (14) based at least in part on a current order backlog for the seller (14). A food order transaction broker (18) receives a request for at least one food item from a buyer (12) and generates a list of one or more sellers (14) of the requested food item according to a comparison of the requested food item with the availability information for each seller (14) and a comparison of the delivery information for the buyer (12) with the delivery area of each seller (14). The list reflects the pricing information for the requested food item for each listed seller (14) and the substantially real-time delivery time information for each listed seller (14). The broker (18) initiates a food order transaction concerning the requested food item with a particular listed seller (14) selected from the list.

### BACKGROUND OF THE INVENTION

Food delivery is a common alternative to ordering “take out” or preparing food oneself, particularly where time is limited. Despite its relative convenience, however, food delivery may involve considerable hassle from the perspective of the customer. For example, delivery orders typically must be placed over the telephone, but the customer may know little or nothing about local restaurants, and restaurant telephone numbers may not be readily available to the customer. The customer may struggle to identify a particular restaurant and may then have to call “information” or look up the telephone number of the restaurant in a telephone book, assuming a telephone book is even available. After obtaining the telephone number of a particular restaurant, the customer may call only to find out the restaurant does not deliver to the customer's area, or the delivery time for the restaurant is unsatisfactory. When the customer finally locates a suitable restaurant, the customer may encounter difficulty in placing an order. For example, the customer may have to wait on the telephone while the person taking orders for the restaurant tends to other customers. Moreover, the customer may be unfamiliar with the restaurant's menu and, as a result, may have to ask several questions about what food items are available at the restaurant. Even if the customer has an idea of what food items are available, the customer may be under pressure to quickly choose one or more items. In placing the order, the customer may have to relay to the person taking orders the customer's deliver-to address or other delivery instructions, at the expense of additional time. Many of these difficulties are similarly associated with placing food delivery orders using the Internet.

From the perspective of a restaurant, it may be costly and inefficient to receive delivery orders over the telephone. For example, a restaurant may need to dedicate a person to take delivery orders over the telephone, adding to labor costs and possibly negatively impacting other important tasks. Assuming that it takes, on average, two minutes to take and process a delivery order made by telephone and that a restaurant receives, on average, one hundred orders per day, the employees whose duties include taking delivery orders must collectively spend, on average, two hundred minutes per day taking orders, taking significant time away from other tasks. These difficulties are not fully ameliorated where delivery orders are received using the Internet.

As a result of one or more of these or other deficiencies, previous techniques for facilitating food ordering and delivery have been inadequate for many customers and restaurants.

### SUMMARY OF THE INVENTION

According to the present invention, disadvantages and problems associated with food ordering and delivery are substantially reduced or eliminated.

In one embodiment, a system for brokering food order transactions among multiple unaffiliated sellers includes one or more databases containing delivery information associated with each of possibly multiple buyers, availability information identifying food items available from each of multiple unaffiliated sellers, pricing information for the food items available from each seller, and delivery information for each seller. The delivery information includes a delivery area for the seller and substantially real-time delivery time information for the seller that is based at least in part on a current order backlog for the seller. A food order transaction broker receives a request for at least one food item from a buyer and generates a list of one or more sellers of the requested food item according to a comparison of the requested food item with the availability information for each seller and a comparison of the delivery information for the buyer with the delivery area of each seller. The list reflects the pricing information for the requested food item for each listed seller and the substantially real-time delivery time information for each listed seller. The broker initiates a food order transaction concerning the requested food item with a particular listed seller selected from the list.

The present invention provides a number of important technical advantages over previous techniques. A customer may order food for delivery without the hassle of identifying a particular restaurant, looking up or otherwise determining the restaurant's telephone number, and then calling the restaurant to determine whether its available food items and current delivery schedule meet the customer's needs, saving the customer considerable time. Moreover, the present invention gives the customer the freedom to examine all available options in the comfort of, for example, the customer's home or office. The present invention also enables the customer to compare current prices and delivery times for a requested food item for a number of listed restaurants, all of which may have been pre-screened according to stored customer preferences, before selecting a particular restaurant. Efficiency may be further increased where the listed sellers are ranked, according to price or delivery time for example, or where a particular seller is selected from the list automatically. From the perspective of a restaurant, the present invention releases one or more employees from duties associated with taking delivery orders over the telephone, reducing labor costs. The present invention also provides faster order processing, may allow for the efficient distribution of orders to delivery personnel according to their location, thereby optimizing their utilization, and gives restaurants an additional avenue for reaching customers and selling food.

Current techniques, even those involving use of the Internet, fail to provide one or more of these advantages. Systems and methods incorporating one or more of these or other technical advantages are well suited for modern electronic commerce environments. Other technical advantages are readily apparent to those skilled in the art from the following figures, descriptions, and claims.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates an exemplary system for brokering food order transactions among a plurality of unaffiliated sellers; and

FIG. 2 illustrates an exemplary method for brokering food order transactions among a plurality of unaffiliated sellers.

### DETAILED DESCRIPTION OF THE INVENTION

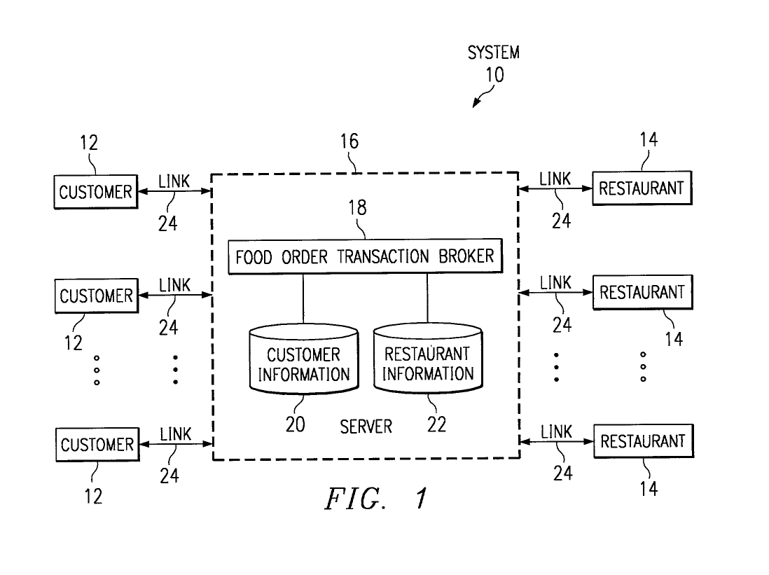

FIG. 1 illustrates an exemplary system 10 for brokering food order transactions among a plurality of unaffiliated sellers. System 10 includes one or more customers 12, one or more restaurants 14, and at least one server 16 associated with a website or other environment accessible to customers 12 and restaurants 14. In general, server 16 receives a request for a food item from a customer 12 and, in response, generates and provides to the customer 12 a list of restaurants 14 from which the requested food item is available and which deliver to the location of the customer 12. The list preferably excludes all restaurants 14 from which the requested food item is not available or which do not deliver to the location of the customer 12. For each restaurant 14 on the list, the list may reflect pricing information for the requested food item and substantially real-time delivery time information for purposes of comparison by the customer 12 or automatically. The listed sellers may be ranked according to such information. Server 16 may initiate a food order transaction with a restaurant 14 selected from the list by the customer 12 or automatically. To perform these or any other tasks, server 16 may use a food order transaction broker 18, customer information 20, and restaurant information 22.

Customers 12 may include any appropriate entities that may access server 16 to request one or more food items for delivery to corresponding customer locations, and restaurants 14 may include any appropriate unaffiliated entities offering to sell food items to customers 12 and arrange for delivery of those food items to customer locations. For example, restaurants 14 might include multiple unaffiliated pizza restaurants that arrange for delivery of pizza within a certain area, either through employee drivers or another entity, and customers 12 might include persons accessing server 16 to order pizza for delivery. Reference to a customer 12 or restaurant 14 is meant to encompass one or more associated computers and, where appropriate, one or more associated persons. However, one or more customers 12, restaurants 14, or both may operate autonomously according to particular needs. As used in this document, the term “computer” is meant to encompass a workstation, person computer, personal digital assistant (PDA), wireless telephone, or any other suitable computing device. Customers 12, restaurants 14, and server 16 may be coupled to each other using links 24 that each include one or more local area networks (LANs), metropolitan area networks (MANs), wide area networks (WANs), a portion of the global computer network known as the Internet, or any other appropriate wireline, wireless, or other links. The components of server 16 may operate on one or more computers at one or more locations, and server 16 may share one or more computers or other resources with one or more customers 12 or one or more restaurants 14, according to particular needs. Customer requests may be submitted to server 16 in any suitable format, such as in the form of Hypertext Markup Language (HTML) files.

Associated with server 16 are one or more databases, at one or more locations integral to or separate from server 16, containing customer information 20 and restaurant information 22. Although databases are primarily described, customer information 20 and restaurant information 22 may be stored using any suitable data storage arrangement. Customer information 20 for a customer 12 may include customer delivery information, customer preference information, customer payment information, or any other suitable information associated with the customer 12. Customer delivery information for a customer 12 may include any suitable information relating to contacting and delivering to the customer 12, such as a deliver to address including a street address and preferably a city, zip code, or both; one or more telephone numbers or portions thereof, such as an area code; or special delivery instructions.

Customer preference information for a customer 12 may include any information relating to the personal preferences of the customer 12. For example, in one embodiment, the customer preference information for customer 12 may include maximum and/or minimum price preferences, maximum delivery time preferences, and restaurant rating preferences of the customer 12. A particular preference of a customer 12 may be represented in any appropriate manner. For example only and not by way of limitation, the customer preference information for customer 12 may indicate that delivery time is “very important,” “important,” or “unimportant” to the customer 12 or, more specifically, that a delivery time of more than thirty minutes is unacceptable to the customer 12. Price preferences, restaurant rating preferences, and any other appropriate customer preferences may be similarly represented.

Customer payment information for a customer 12 may include any information relating to payment by the customer 12 for food items, such as a preferred method of payment, a credit card number, or any other suitable payment information.

Server 16 preferably stores customer information 20 such that a customer 12 need not provide customer information 20 each time the customer 12 accesses server 16. For example, a customer 12 may register with server 16 the first time customer 12 accesses server 16, providing customer information 20 such as customer delivery information, customer preference information, and customer payment information that server 16 may use when customer 12 accesses server 16 in the future. A customer 12 accessing server 16 who has previously registered may log on to server 16, using a username and password for example, to allow server 16 to identify customer 12 for purposes of locating customer information 20 for customer 12. Once stored, customer information 20 for a particular customer 12 may be updated by that customer 12 or otherwise according to particular needs.

Restaurant information 22 for a restaurant 14 may include any suitable information associated with the restaurant 14, such as food availability information, pricing information, delivery area information, delivery time information, and rating information for restaurant 14.

Food availability information for a restaurant 14 may include any information relating to the availability of one or more food items from restaurant 14 and may be substantially real-time in that the food availability information may be updated by restaurant 14 as needed to reflect the current availability of food items from restaurant 14. For example, if a restaurant 14 suddenly runs out of a food item or an ingredient of a food item such that the food item may not be prepared or is otherwise currently unavailable from restaurant 14, restaurant 14 may update its food availability information so that customers 12 accessing server 16 may be notified accordingly.

Pricing information for a restaurant 14 may include any information reflecting the prices of food items offered by restaurant 14, such as regular prices or any “specials” currently being offered. Pricing information for restaurant 14 may be substantially real-time in that restaurant 14 may update the pricing information as needed to reflect the current prices of food items available from restaurant 14.

Delivery area information for a restaurant 14 may include any information relating to the geographical area within which restaurant 14 may deliver or arrange for delivery of food items, such as a listing of cities, zip codes, neighborhoods, streets, or other geographic identifiers.

Delivery time information for a restaurant 14 may include any information relating to the delivery time for food items ordered from restaurant 14. For example, delivery time information may reflect a current order backlog at restaurant 14 for all food items or a particular food item, the amount of time it may take restaurant 14 to prepare all food items or a particular food item, and the travel time from restaurant 14 to various locations. Delivery time information may reflect one or more actual delivery times for restaurant 14 or an estimated delivery time that is based on one or more actual delivery times for restaurant 14 within a prescribed time period, such as a predetermined time period preceding a request received from a customer 12. Delivery time information for restaurant 14 may be substantially real-time in that it may be updated by restaurant 14 or otherwise as needed to reflect the current delivery time for restaurant 14. Delivery time information may vary for different food items for the same restaurant 14.

Rating information for a restaurant 14 may include any information reflecting the overall quality of restaurant 14 or the quality of one or more characteristics of restaurant 14. For example, rating information may reflect the quality of a particular food item at restaurant 14, the quality of a category of food items at restaurant 14, or the quality of delivery or other service at restaurant 14. A particular rating may be indicated using a number or a more qualitative indicator, such as a word or phrase for example, or in any other appropriate manner. Moreover, a rating may be generated in any appropriate manner. For example, a rating may represent an average score given by past customers 12 or a score given by a food critic or the like.

Broker 18 may perform a number of tasks associated with brokering food order transactions among multiple unaffiliated restaurants 14. Broker 18 receives requests for food items from customers 12 and, in response, generates corresponding lists of restaurants 14 according to appropriate criteria. Broker 18 may generate a list of restaurants 14 according to a comparison of the availability information for one or more restaurants 14 with the one or more food items identified in the customer request. For example, if customer 12 has requested a pepperoni pizza, broker 18 may exclude from the list of restaurants 14 those restaurants 14 at which pepperoni pizza is not currently available. Broker 18 may also generate the list of restaurants 14 according to a comparison of the customer delivery information for customer 12 with the delivery area information for each restaurant 14, excluding from the list those restaurants 14 that do not deliver to the location of customer 12. Broker 18 may further generate the list of restaurants 14 according to a comparison of the customer preference information for customer 12 with the pricing information, delivery time information, and/or rating information for each restaurant 14, excluding from the list those restaurants 14 that do not satisfy some or all of the preferences of customer 12. For example, if customer preference information for customer 12 indicates that a delivery time longer than thirty minutes is unacceptable, broker 18 may exclude from the list those restaurants 14 with a current delivery time longer than thirty minutes. Broker 18 may determine the preferences of customer 12 by accessing stored customer information 20 for customer 12 or by eliciting from customer 12 any special instructions or the like applicable to a submitted request. Broker 18 may generate the list of restaurants 14 according to any of the criteria described above, singly or in any suitable combination and without limitation.

The list of restaurants 14 may be communicated to customer 12 formatted in any appropriate manner and containing any suitable information according to particular needs. For example, in one embodiment, the list may reflect substantially real-time or other pricing information and substantially real-time or other delivery time information for the requested food item(s) for each restaurant 14 on the list, allowing customer 12 to compare the prices and delivery times offered by restaurants 14 before making a selection. The list may also reflect any suitable rating information for each restaurant 14 on the list. For example, if customer 12 has requested lasagna, the list may indicate the rating that each restaurant 14 on the list has received for its lasagna or generally, giving customer 12 an idea of the quality of the lasagna at each of the restaurants 14 on the list. Broker 18 preferably also ranks the restaurants 14 on the list according to one or more suitable criteria. For example, the first listed restaurant 14 may offer the shortest delivery time, the second listed restaurant 14 may offer the second shortest delivery time, and so on. Broker 18 may use restaurant pricing information, restaurant delivery time information, restaurant rating information, customer preference information, or any other suitable information, singly or in any suitable combination and without limitation, to rank the restaurants 14 on the list.

In addition to generating a list of restaurants 14 in response to the request received from customer 12, broker 18 may also generate a list of restaurants 14 offering one or more alternative food items, allowing customer 12 to compare the prices, delivery times, restaurant ratings, and the like for the alternative food item(s) with those of the requested food item(s). For example, if customer 12 has requested a thin-crust pepperoni pizza, broker 18 may generate, in addition to the list corresponding to the requested food item, a list corresponding to a deep-dish pizza with numerous toppings in addition to pepperoni. This may be intended to provide customer 12 with more options or to enhance up-selling, cross-selling, or other sales opportunities for one or more restaurants 14. For example, server 16 may support a fee-based service through which certain restaurants 14 become eligible for inclusion on such alternative lists. Similarly, broker 18 may generate an additional alternative list of restaurants 14 according to criteria that differ from the customer preference information for customer 12. In this way, customer 12 may be shown how one or more aspects of the submitted request has limited the options available to customer 12.

After a list of restaurants 14 has been generated, the food order transaction broker 18 may initiate a food order transaction with a particular restaurant selected from the list by customer 12 or otherwise. In one embodiment, broker 18 communicates the generated list(s) of restaurants 14 to customer 12, receives from customer 12 a selection of a particular restaurant 14 on the list, and initiates a food order transaction with the selected restaurant 14 in response to the selection. One or more lists of restaurants 14 may be provided to customer 12 in any suitable manner. For example, a list may be provided to customer 12 in HTML format for rendering and display using an associated web browser. Alternatively, broker 18 may select a particular restaurant 14 automatically before initiating the transaction, with or without prompting from customer 12 and perhaps without communicating any list to customer 12. Broker 18 may automatically select a restaurant for customer 12 according to any suitable criteria. For example, in one embodiment, broker 18 compares the customer preference information for customer 12 with restaurant information 22, such as price, delivery time, and rating, for each restaurant 14 on the list and selects the particular restaurant 14 that customer 12 would most likely select in light of the customer preference information.

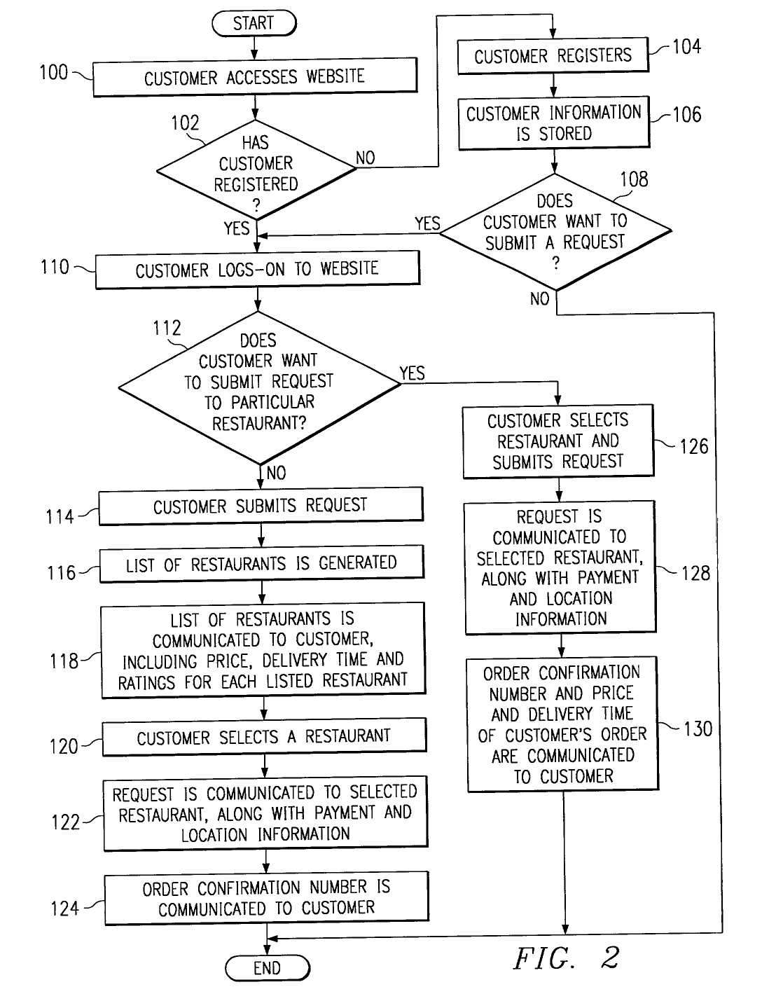

FIG. 2 illustrates an exemplary method of brokering food order transactions among multiple unaffiliated sellers. The method begins at step 100, where customer 12 accesses server 16. At step 102, if customer 12 has not previously registered with server 16, customer 12 may register with server 16 at step 104. When customer 12 registers, customer 12 preferably provides customer information 20, such as customer delivery information, customer payment information, customer preference information, or any other suitable customer information 20, that broker 18 or restaurants 14 may use for this or future transactions. At step 106, server 16 stores the customer information 20 received from customer 12. Customer 12 is then given the choice, at step 108, of submitting a request for one or more food items. If customer 12 chooses not to submit a request at this time, the method ends. Otherwise, the method proceeds to step 110 described below.

Referring again to step 102, if customer 12 has registered with server 16, the method proceeds to step 110, where customer 12 logs on to server 16. After customer 12 has logged on, customer 12 is given the choice, at step 112, of submitting a request to a particular restaurant 14 or being provided a list of restaurants 14 in response to a submitted request. If customer 12 chooses to be provided a list of restaurants 14, customer 12 submits a request for at least one food item at step 114. For example, if customer 12 wants to order pizza, customer 12 may “build” a pizza from a list of toppings and crusts. In response to the submitted request, broker 18 generates a list of restaurants 14 at step 116. As discussed above, the list of restaurants 14 may be generated according to any suitable criteria. For example, in one embodiment, broker 18 generates the list according to a comparison of the food item in the request with the availability information for each restaurant 14 and a comparison of the delivery information for customer 12 with the delivery area information for each restaurant 14, excluding from the list those restaurants 14 that do not offer the requested food item or do not deliver to the location of customer 12. At step 118, broker 18 may communicate the generated list to customer 12. In one embodiment, the list reflects the pricing information, substantially real-time delivery time information, and rating information corresponding to the requested food item for each restaurant 14 on the list. As described above, however, the list communicated to customer 12 may contain any suitable information, according to particular needs. After reviewing the list, customer 12 selects a restaurant 14 from the list at step 120. As described above, instead of customer 12 selecting a restaurant 14 from the list of restaurants 14, broker 18 may select a restaurant 14 automatically according to customer preference information for customer 12. After a restaurant 14 from the list of restaurants 14 has been selected, broker 18 communicates the request to the selected restaurant 14 at step 122 along with any stored payment and delivery information for customer 12. At step 124, broker 18 may communicate to customer 12 an order confirmation number, and the method ends.

Referring again to step 112, if customer 12 chooses to order from a particular restaurant 14 without first comparing prices and delivery times for restaurants 14 delivering to the location of customer 12, the method proceeds to step 126, where customer 12 may select a particular restaurant 14 from a listing of all restaurants 14, browse a menu for the restaurants 14, and submit a request for at least one food item using conventional techniques. At step 128, broker 18 communicates the request to the selected restaurant 14, along with any payment and delivery information for customer 12. Broker 18 may communicate the request to the selected restaurant 14 such that the restaurant 14 can efficiently distribute delivery orders to delivery personnel according to the location of the personnel, thereby optimizing their utilization. Broker 18 may then communicate an order confirmation number and perhaps the delivery time for the order to customer 12 at step 130, and the method ends.

Although the present invention has been described with several embodiments, divers changes, variations, alterations, transformations, and modifications may be suggested to one skilled in the art, and it is intended that the present invention encompass such changes, variations, alterations, transformations, and modifications as fall within the spirit and scope of the appended claims.

What is claimed is:

1. A system for brokering food order transactions among a plurality of unaffiliated sellers, comprising:
one or more databases containing:
delivery information associated with each of a plurality of buyers;
availability information identifying food items available from each of a plurality of unaffiliated sellers;
pricing information for the food items available from each seller; and
delivery information for each seller comprising a delivery area for the seller and substantially real-time delivery time information for the seller based at least in part on a current order backlog for the seller; and
a food order transaction broker operable to:
receive a request for at least one food item from a buyer;
generate a list of one or more sellers of the requested food item according to a comparison of the requested food item with the availability information for each seller and a comparison of the delivery information for the buyer with the delivery area of each seller, the list reflecting the pricing information for the requested food item for each listed seller and the substantially real-time delivery time information for each listed seller; and
initiate a food order transaction concerning the requested food item with a particular listed seller selected from the list.

2. The system of claim 1, wherein the buyer delivery information is selected from the group consisting of a buyer area code, a buyer city, a buyer zip code, and a buyer street address.

3. The system of claim 1, wherein the pricing information for at least one of the food items reflects a currently available special offer for the food item.

4. The system of claim 1, wherein the substantially real-time delivery time information for at least one of the listed sellers comprises an estimated delivery time determined based on one or more actual delivery times for the listed seller within a predetermined time period preceding the request.

5. The system of claim 1, wherein the substantially real-time delivery time information for at least one of the listed sellers comprises a recent actual delivery time for the listed seller.

6. The system of claim 1, wherein the broker is further operable to rank the listed sellers according to at least the substantially real-time delivery time information for each listed seller.

7. The system of claim 1, wherein:
the one or more databases further contain preference information for the buyer; and
the broker is operable to generate the list according to the preference information for the buyer, the list excluding any sellers for which the pricing information or the substantially real-time delivery time information does not satisfy the preference information for the buyer.

8. The system of claim 1, wherein the broker is further operable to communicate to the buyer a suggested alternative food item available from one or more of the sellers, along with the pricing information and substantially real-time delivery time information for the alternative food item for each of these sellers, if the substantially real-time delivery time information for one or more of the listed sellers exceeds a threshold.

9. The system of claim 1, wherein the availability information for at least one of the sellers comprises substantially real-time availability information reflecting a current shortage of one or more food items normally available from the seller.

10. The system of claim 1, wherein:
the one or more databases further contain rating information for one or more of the sellers; and
the broker is further operable to communicate to the buyer the rating information for at least one listed seller in association with the pricing and substantially real-time delivery time information for the listed seller.

11. The system of claim 1, wherein the broker is further operable to:
communicate the list to the buyer;
receive from the buyer a selection of a particular listed seller; and
initiate the food order transaction with the particular listed seller in response to the selection.

12. The system of claim 1, wherein the broker is further operable to select the particular listed seller automatically according to at least the substantially real-time delivery time information for all of the listed sellers.

13. Software for brokering food order transactions among a plurality of unaffiliated sellers, the software being embodied in a computer-readable medium and when executed by a computer operable to:
receive a request for at least one food item from a buyer;
access one or more databases containing:
delivery information for the buyer;
availability information identifying food items available from each of a plurality of unaffiliated sellers;
pricing information for the food items available from each seller; and
delivery information for each seller comprising a delivery area for the seller and substantially real-time delivery time information for the seller based at least in part on a current order backlog for the seller;
generate a list of one or more sellers of the requested food item according to a comparison of the requested food item with the availability information for each seller and a comparison of the delivery information for the buyer with the delivery area of each seller, the list reflecting the pricing information for the requested food item for each listed seller and the substantially real-time delivery time information for each listed seller; and
initiate a food order transaction concerning the requested food item with a particular listed seller selected from the list.

14. The software of claim 13, wherein the buyer delivery information is selected from the group consisting of a buyer area code, a buyer city, a buyer zip code, and a buyer street address.

15. The software of claim 13, wherein the pricing information for at least one of the food items reflects a currently available special offer for the food item.

14. The software of claim 13, wherein the substantially real-time delivery time information for at least one of the listed sellers comprises an estimated delivery time determined based on one or more actual delivery times for the listed seller within a predetermined time period preceding the request.

15. The software of claim 13, wherein the substantially real-time delivery time information for at least one of the listed sellers comprises a recent actual delivery time for the listed seller.

16. The software of claim 13, further operable to rank the listed sellers according to at least the substantially real-time delivery time information for each listed seller.

17. The software of claim 13, wherein:
the one or more databases contain preference information for the buyer; and
the software is further operable to generate the list according to the preference information for the buyer, the list excluding any sellers for which the pricing information or the substantially real-time delivery time information does not satisfy the preference information for the buyer.

18. The software of claim 13, further operable to initiate communication to the buyer of a suggested alternative food item available from one or more of the sellers, along with the pricing information and substantially real-time delivery time information for the alternative food item for each of these sellers, if the substantially real-time delivery time information for one or more of the listed sellers exceeds a threshold.

19. The software of claim 13, wherein the availability information for at least one of the sellers comprises substantially real-time availability information reflecting a current shortage of one or more food items normally available from the seller.

20. The software of claim 13, wherein:
the one or more databases contain rating information for one or more of the sellers; and
the software is further operable to initiate communication to the buyer of the rating information for at least one listed seller in association with the pricing and substantially real-time delivery time information for the listed seller.

21. The software of claim 13, further operable to:
initiate communication of the list to the buyer;
receive from the buyer a selection of a particular listed seller; and
initiate the food order transaction with the particular listed seller in response to the selection.

22. The software of claim 13, further operable to select the particular listed seller automatically according to at least the substantially real-time delivery time information for all of the listed sellers.

23. A system for brokering food order transactions among a plurality of unaffiliated sellers, comprising:
means for storing:
delivery information associated with each of a plurality of buyers;
availability information identifying food items available from each of a plurality of unaffiliated sellers;
pricing information for the food items available from each seller; and
delivery information for each seller comprising a delivery area for the seller and substantially real-time delivery time information for the seller based at least in part on a current order backlog for the seller;
means for receiving a request for at least one food item from a buyer;
means for generating a list of one or more sellers of the requested food item according to a comparison of the requested food item with the availability information for each seller and a comparison of the delivery information for the buyer with the delivery area of each seller, the list reflecting the pricing information for the requested food item for each listed seller and the substantially real-time delivery time information for each listed seller; and
means for initiating a food order transaction concerning the requested food item with a particular listed seller selected from the list.

24. A method of brokering food order transactions among a plurality of unaffiliated sellers, comprising:
receiving a request for at least one food item from a buyer;
accessing one or more databases containing:
delivery information for the buyer;
availability information identifying food items available from each of a plurality of unaffiliated sellers;
pricing information for the food items available from each seller; and
delivery information for each seller comprising a delivery area for the seller and substantially real-time delivery time information for the seller based at least in part on a current order backlog for the seller;
generating a list of one or more sellers of the requested food item according to a comparison of the requested food item with the availability information for each seller and a comparison of the delivery information for the buyer with the delivery area of each seller, the list reflecting the pricing information for the requested food item for each listed seller and the substantially real-time delivery time information for each listed seller; and
initiating a food order transaction concerning the requested food item with a particular listed seller selected from the list.

25. The method of claim 24, wherein the buyer delivery information is selected from the group consisting of a buyer area code, a buyer city, a buyer zip code, and a buyer street address.

26. The method of claim 24, wherein the pricing information for at least one of the food items reflects a currently available special offer for the food item.

27. The method of claim 24, wherein the substantially real-time delivery time information for at least one of the listed sellers comprises an estimated delivery time determined based on one or more actual delivery times for the listed seller within a predetermined time period preceding the request.

28. The method of claim 24, wherein the substantially real-time delivery time information for at least one of the listed sellers comprises a recent actual delivery time for the listed seller.

29. The method of claim 24, further comprising ranking the listed sellers according to at least the substantially real-time delivery time information for each listed seller.

30. The method of claim 24, wherein:
the one or more databases contain preference information for the buyer; and
the method further comprises generating the list according to the preference information for the buyer, the list excluding any sellers for which the pricing information or the substantially real-time delivery time information does not satisfy the preference information for the buyer.

31. The method of claim 24, further comprising communicating to the buyer a suggested alternative food item available from one or more of the sellers, along with the pricing information and substantially real-time delivery time information for the alternative food item for each of these sellers, if the substantially real-time delivery time information for one or more of the listed sellers exceeds a threshold.

32. The method of claim 24, wherein the availability information for at least one of the sellers comprises substantially real-time availability information reflecting a current shortage of one or more food items normally available from the seller.

33. The method of claim 24, wherein:
the one or more databases contain rating information for one or more of the sellers; and
the method further comprises communicating to the buyer the rating information for at least one listed seller in association with the pricing and substantially real-time delivery time information for the listed seller.

34. The method of claim 24, further comprising:
communicating the list to the buyer;
receiving from the buyer a selection of a particular listed seller; and
initiating the food order transaction with the particular listed seller in response to the selection.

35. The method of claim 24, further comprising selecting the particular listed seller automatically according to at least the substantially real-time delivery time information for all of the listed sellers.
